(19) United States
(12) Patent Application Publication
(10) Pub. No.: US 2002/0136142 A1
(43) Pub. Date: Sep. 26, 2002

(54) Optical data storage medium based on the luminescence from the crystalline semiconductor and optical storage/reading device and method using two-photon absorption

(76) Inventors: Sang Don Jung, Taejon (KR); Myung-Ae Chung, Taejon (KR); Young Jun Kim, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/032,752

(22) Filed: Dec. 26, 2001

(30) Foreign Application Priority Data
Mar. 21, 2001 (KR) 2001-14626

(51) Int. Cl. G11B 7/135; G11B 7/24

(52) U.S. Cl. 369/94; 369/283; 369/112.22; 369/121

(57) ABSTRACT

The present invention relates to an optical data storage medium and a device and method thereof; and, more particularly, to an optical data storage medium based on semiconductor luminescence, which is capable of limiting searching and recording of optical data to a certain location in three-dimensional, easy multi-stage data searching, controlling of luminescence wavelength, excellent durability of data, requiring relatively low energy compared to a method of damaging silica, one-time-recording and repeated-searching, and to a device and method for searching for and recording optical data based on the photon absorption effect. The method of recording optical data takes a semiconductor-dispersed-thin layer on an optically transparent medium as a recording layer. Data recorded in a certain layer is searched based on the luminescence property of nanometer-sized crystalline semiconductor by using single-photon or two-photon absorption.

### FIELD OF THE INVENTION

The present invention relates to an optical data storage medium; and, more particularly, to an optical data storage medium based on luminescence of crystalline semiconductor and an optical device for recording and searching an optical data based on two-photon absorption effect and a method therefor.

### DESCRIPTION OF THE PRIOR ART

Conventionally, optical data storage technology uses the reflection property of a laser beam when searching optical data recorded in a CD (compact disk) or DVD (digital versatile disc).

As an effort to increase storage capacity of an optical disk, there is a multi-layer recording method that makes more than one recording layer in a single disk. The method using the reflective property of a laser beam, however, is known hard to make the layers more than four, because the amount of the light beam reflected from a certain layer dispersed by other recording layers gets larger, as the number of recording layers increases, thus reducing the ratio of noise to signal. Another method of multi-layer recording suggests making use of luminescence of a laser beam instead of the reflection property. In case of a read only memory (ROM), this method forms a plurality of recording layers filled with an organic material which is luminous when a ROM is excited by a laser beam though a micro hole, and searches for data recorded on a bit basis in a recording layer you want by rotating the disk and controlling the focus of the laser beam up and down. The peak luminescence wavelength emitted from the organic material used here is different from that of a laser used for searching.

In case of a WROM, a medium of recording data one-time and capable of searching repeatedly, it is possible to store data on a bit basis in a recording layer you want by forming a plurality of recording layers evenly filled with a luminous material, rotating the disk and controlling the focus of a laser beam up and down. Storing data on a bit basis transforms the chemical structure of the luminous organic material with an intensive laser beam and stops it from illuminating. In a multi-layer recording method based on luminescence, the intensity of the luminescence is the highest at the focus of a beam because it goes in proportion to the intensity of the beam radiating. In this method, light is emitted not only in the record where the beam focuses but in the adjacent recording area as well because a laser of a wavelength whose energy is higher than the band gap of the luminous material. So a light intensity filter is needed to make distinct between them, and conditions for manufacturing a data storage medium for uniform light intensity becomes strict.

Also, in a conventional method, the silica bond is disconnected by condensing a primary pulse beam on a transparent silica (SiO₂), and thus luminescent section limited in three-dimensional can be formed. But this technique damages silica as much as to disconnect the bond between silicon and oxygen atoms (Si—O) locally, requiring high energy.

### SUMMARY OF THE INVENTION

It is, therefore, an object of the present invention to provide an optical data storage medium based on semiconductor luminescence, which is capable of limiting searching and storing of optical data to a certain location in three-dimensional, easy multi-stage data searching, controlling of luminescence wavelength, excellent durability of data, requiring relatively low energy compared to a method of damaging silica, one-time-recording and repeated-searching, and a device and method for searching for and storing optical data based on photon absorption.

In accordance with an aspect of the present invention, there is provided an optical data storage medium, including: a plurality of recording layers, each of the recording layers being transparent to a light beam incident thereto and dispersed with a semiconductor material; and a number of spacers formed adjacent to the recording layers.

In accordance with another aspect of the present invention, there is provided an optical data storage device, including: a first laser generating unit for generating a first laser beam; a first light generating unit having a first condensing unit placed in the lower part of the first laser generating unit, for injecting the laser released from the first laser generating unit to the optical data storage medium; and an optical data medium supporting unit placed in the lower part of the first light generating unit.

In accordance with further another embodiment of the present invention, there is provided an optical data recording and searching device, including:

a first laser generating unit for generating a first laser beam; a first condensing unit placed in the lower part of the first laser generating unit for injecting the laser released from the first laser generating unit to the optical data storage medium; an optical separating unit placed between the first laser generating unit and the condensing unit, for separating the laser beam and the luminescence beam; a first light generating and detecting unit having a light detecting unit for detecting the luminescence beam transmitted from the optical separating unit; and an optical data medium supporting unit placed in the lower part of the first light generating and detecting unit.

In accordance with further another aspect of the present invention, there is provided a method for recording optical data based on an optical data storage device, wherein the optical data storage device includes a first laser generating unit, a first light generating unit and an optical data medium supporting unit, the method including the steps of: a) placing an optical data storage medium in which a plurality of transparent thin layers dispersed with semiconductor and transparent space layers are piled up alternately on the lower part of the first light generating unit; b) rotating the optical data storage medium and arraying focus of the beam released from the first light generating unit on the data recording region; and c) radiating the laser beam according to data binary code signals and crystallizing the data recording region by treating thermally.

In accordance with further another aspect of the present invention, there is provided a method for recording optical data based on an optical data storage device, wherein the optical data storage device includes a first laser generating unit, a first light generating unit, a second laser generating unit, a second light generating unit and an optical data medium supporting unit, the method including the steps of: a) placing an optical data storage medium in which a plurality of transparent thin layers dispersed with semiconductor and transparent space layers are piled up alternately between the first light generating unit and the second light generating unit; b) rotating the optical data storage medium and arraying the focus of each beam released from the first and second light generating unit to be crossed on the data recording region; and c) radiating laser beams from the first and second laser generating unit according to data binary code signals and crystallizing the data recording region by treating thermally.

In accordance with still further aspect of the present invention, there is provided a method for searching for optical data based on an optical data storage and detection device, wherein the optical data storage and detection device includes a first laser generating unit, a first condensing unit, an optical separating unit, a first light generating and detecting unit and an optical data medium supporting unit, the method including the steps of: a) placing an optical data storage medium in which a plurality of transparent thin layers dispersed with semiconductor and transparent space layers are piled up alternately in the lower part of the first light generating and detecting unit; b) rotating the optical data storage medium and arraying the focus of a beam released from the first laser generating unit on a certain data searching region; c) radiating a laser on the data searching region; and d) detecting the luminescence obtained from the crystalline semiconductor with a light detecting unit of the first light generating and detecting unit.

In accordance with still further aspect of the present invention, there is provided a method of optical data searching based on an optical data storage and detection device, wherein the optical data storage and detection device includes a first laser generating unit, a first condensing unit, an optical separating unit, a first light generating and detecting unit, an optical data medium supporting unit, a second laser generating unit and a second light generating unit, the method including the steps of: a) placing an optical data storage medium in which a plurality of transparent thin layers dispersed with semiconductor and transparent space layers are piled up alternately between the first light generating and detecting unit and the second light generating and detecting unit; b) rotating the optical data storage medium and arraying the focus of each beam released from the first and the second laser generating unit to be crossed on a data searching region; c) radiating a laser from the first and second laser generating unit on the searching region; and d) detecting the luminescence obtained from the crystalline semiconductor with a light detecting unit of first light generating and detecting unit.

### BRIEF DESCRIPTION OF THE DRAWINGS

The above and other objects and features of the present invention will become apparent from the following description of the preferred embodiments given in conjunction with the accompanying drawings, in which:

FIG. 1A is a cross-sectional view showing the structure of an optical data storage medium based on luminescence of crystalline semiconductor in accordance with a preferred embodiment of the present invention;

FIG. 1B is a perspective view showing the shape of the optical data storage medium of FIG. 1A;

FIG. 2 is a schematic view of an optical data storage device based on two-photon absorption in accordance with a second embodiment of the present invention;

FIG. 3 is a schematic view of an optical data storage device based on two-photon absorption in accordance with a third embodiment of the present invention;

FIG. 4 is a schematic view of an optical data storage and searching device based on two-photon absorption in accordance with a fourth embodiment of the present invention; and

FIG. 5 is a schematic view of an optical data storage and searching device based on two-photon absorption in accordance with a fifth embodiment of the present invention.

### DETAILED DESCRIPTION OF THE PREFERRED EMBODIMENTS

Other objects and aspects of the invention will become apparent from the following description of the embodiments with reference to the accompanying drawings, which is set forth hereinafter.

The present invention uses a thin layer where a semiconductor is dispersed on an optically transparent medium as a recording layer, and provides an optical data recording method thermally treating a certain recording layer based on two-photon absorption. The thermal treatment results in the formation of crystalline semiconductor sized nanometers (10−⁹m) in diameter. The crystal formed here has a property of luminescence when excited.

The present invention also provides an optical data searching method, which searches for data recorded in a certain layer by using the single-photon or two-photon absorption effect based on the luminescence of nanometer-sized crystalline semiconductor. The wavelength of the light emitted from the nanometer-sized crystalline semiconductor being excited by a single-photon or two-photon depends on the kind of dispersed semiconductor and the size of the crystal.

The two-photon absorption of a medium having energy gap is in proportion to the multiplication of the intensity of the radiating two beams. So, the absorption is performed where the two radiating beams are crossed or at the focus only. When the energy of each of the two radiating beams is lower than the energy gap of the medium and the sum total of the two energies is higher than the energy gap of the medium, luminescence or photo-chemical reaction is performed at the two-photon absorption region only. Since the luminescence or the photochemical reaction is not performed except the region of two-photon absorption, it is possible to limit the recording and searching of bit-based data into microspace three-dimensionally by cubically crossing two beams. The volume of the micro space is in proportion to the cube of the wavelength of a radiating beam.

Referring to the drawings, the present invention will be described in detail hereinafter.

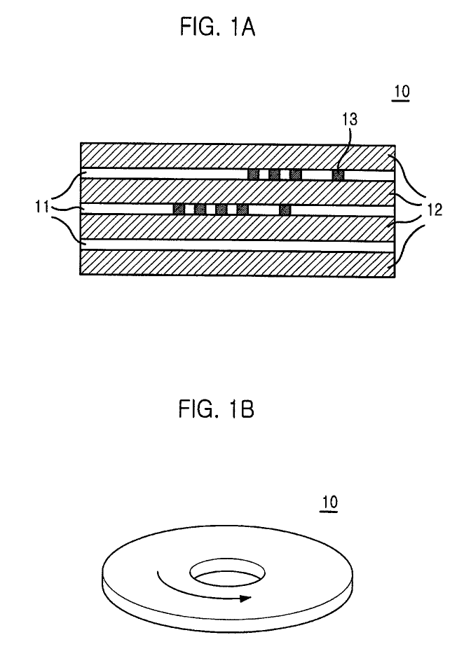

FIG. 1A is a cross-sectional view showing the structure of an optical data storage medium 10 based on luminescence of crystalline semiconductor in accordance with a first embodiment of the present invention, while FIG. 1B is a perspective view showing the shape of the optical data storage medium 10 of FIG. 1A. As shown in FIGS. 1A and 1B, the optical data storage medium 10 based on luminescence of crystalline semiconductor has a plurality of semiconductor dispersion layers 11 and space layers 12 piled up alternately. The semiconductor dispersion layers 11 are thin layers where semiconductor materials having the property of luminescence such as Si and Ge are atomically dispersed on an optically transparent medium when nanometer-sized crystals are formed.

The space layers 12 are layers where the semiconductors are not dispersed on the optically transparent medium. They are shaped like a conventional optical disk as seen in FIG. 1B. Er or Eu can be added to the semiconductor dispersion layers 11.

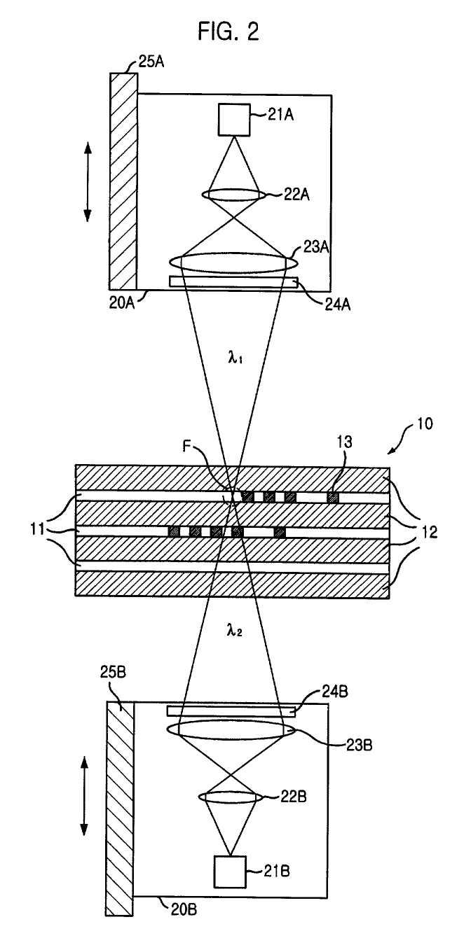

FIG. 2 is a schematic view of an optical data storage device based on two-photon absorption in accordance with a second embodiment of the present invention. The figure shows an array of an upper light generating unit 20A, an optical data storage medium 10 using the luminescence of crystalline semiconductor and a lower light generating unit 20B.

The upper light generating unit 20A comprises a first pulse laser generating unit 21A, a first and second lenses 22A, 23A placed in the lower part of the first pulse laser generating unit 21A and injecting the laser from the first pulse laser generating unit 21A to the optical data storage medium 10, and a first optical filter 24A placed in the lower part of the second lens 23A.

The lower light generating unit 20B comprises a second pulse laser generating unit 21B, a third and fourth lenses 22B, 23B placed in the upper part of the second pulse laser generating unit 21B and injecting the laser from the second pulse laser generating unit 21B to the optical data storage medium 10, and a second optical filter 24B placed in the upper part of the fourth lens 23B. Also, the each upper and lower light generating units 20A, 20B is controlled by the positioning units 25A, 25B connected to such a data processor as a computer so that the location of laser beams radiated from the first and second pulse laser generating units 21A, 21B is adjusted. The first optical filter 24A protects the upper light generating unit 20A from the laser beam generated from the lower light generating unit 20B. The second optical filter 24B protects the lower light generating unit 20B from the laser beam generated from the upper light generating unit 20A. Meanwhile, the optical data storage medium 10 is mounted or arrayed on a medium supporting unit (not shown in figures) placed between the upper light generating unit 20A and lower light generating unit 20B and rotated.

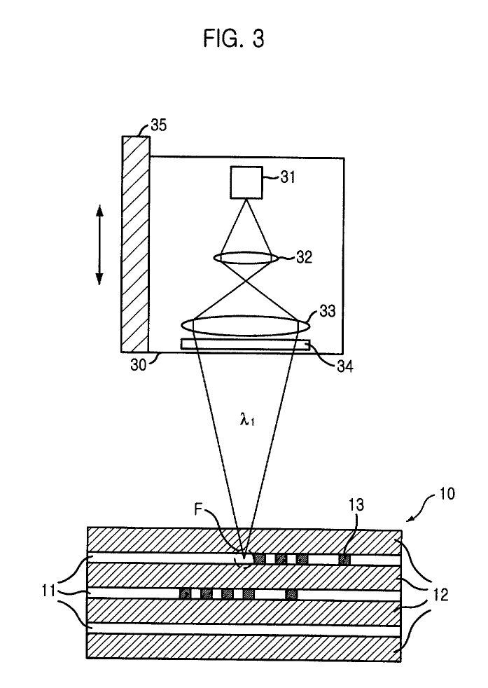

FIG. 3 is a schematic view of an optical data storage device based on two-photon absorption in accordance with a third embodiment of the present invention. The figure shows an array of a light generating unit 30 and an optical data storage medium 10 making use of luminescence property of crystalline semiconductor.

The light generating unit 30 comprises a pulse laser generating unit 31, and a first and second lenses 32, 33 placed in the lower part of the pulse laser generating unit 31 and injecting the laser from the pulse laser generating unit 31 to the optical data storage medium 10. The light generating unit 30 is controlled by the positioning unit 35 connected to such a data processor as a computer so that the location of a laser beams radiated from the pulse laser generating units 31, 41B is adjusted. In the meantime, the optical data storage medium 10 is mounted or arrayed on a medium supporting unit (not shown in figures) placed in the lower part of the light generating unit 30 and rotates.

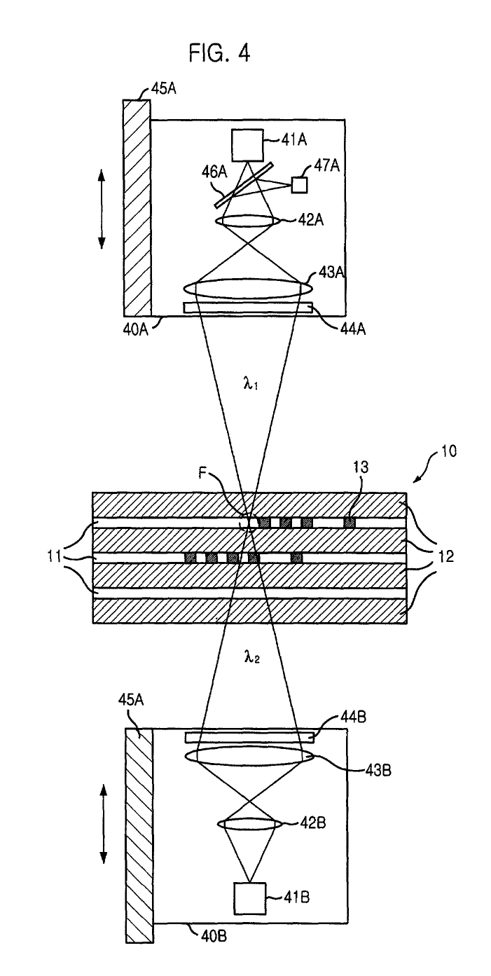

FIG. 4 is a schematic view of an optical data recording and searching device based on two-photon absorption in accordance with a fourth embodiment of the present invention. The figure illustrates an array of an upper light generating and detecting unit 40A, an optical data storage medium 10 using the luminescence property of crystalline semiconductor and a lower light generating unit 40B.

The upper light generating and detecting unit 40A comprises a first pulse laser generator 41A, a first and second lenses 42A, 43A placed in the lower part of the first pulse laser generator 41A and injecting the laser from the pulse laser generator 41A to the optical data storage medium 10, a first optical filter 44A placed in the lower part of the second lens 43A, an optical separator 46A placed between the first pulse laser generator 41A and the first lens 42A for separating the laser beam and the luminescence beam, and an optical detector 47A for detecting the luminescence beam transmitted from the optical separator 46A.

The lower light generating and detecting unit 40B comprises a second pulse laser generator 41B, a third and fourth lenses 42B, 43B placed in the upper part of the second pulse laser generator 41B and injecting the laser from the second pulse laser generator 41A to the optical data storage medium 10, and a second optical filter 44B placed in the upper part of the fourth lens 43B. Also, each upper and lower light generating and detecting units 40A, 40B are controlled by the positioning units 45A, 45A connected to such a data processor as a computer so that the location of laser beams radiated from the first and second pulse laser generators 41A, 41B is adjusted.

The first optical filter 44A protects the upper light generating and detecting unit 40A from the laser beam generated from the lower light generating unit 40B. The second optical filter 44B protects the lower light generating unit 40B from the laser beam generated from the upper light generating and detecting unit 40A. Meanwhile, the optical data storage medium 10 is mounted or arrayed on a medium supporting unit (not shown in figures) placed between the upper light generating and detecting unit 40A and the lower light generating unit 40B and rotates.

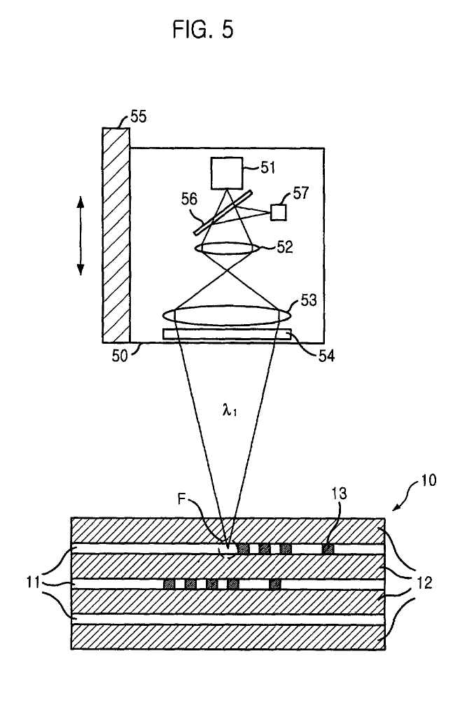

FIG. 5 is a schematic view of an optical data storage and searching device based on two-photon absorption in accordance with a fifth embodiment of the present invention. The figure shows an array of a light generating and detecting unit 50 and an optical data storage medium 10 making use of the luminescence property of crystalline semiconductor.

The light generating and detecting unit 50 comprises a pulse laser generator 51, a first and second lenses 52, 53 placed in the lower part of the pulse laser generator 51 and injecting the laser from the pulse laser generator 51 to the optical data storage medium 10, an optical separator 56 placed between the first pulse laser generator 51 and the first lens 52 for separating the laser beam and the luminescence beam, and an optical detector 57 for detecting the luminescence beam transmitted from the optical separator 56.

The light generating and detecting unit 50 is controlled by the positioning unit 55 connected to such a data processor as a computer so that the location of laser beams radiated from the pulse laser generating unit 51 is adjusted. And the optical data storage medium 10 is mounted or arrayed on a medium supporting unit (not shown in figures) placed at the light generator in the lower part of the light generating and detecting unit 50 and rotates.

A method for storing optical data using an optical data storage device shown in FIG. 2 will be described hereinafter.

the first place, the optical data storage medium 10 of a structure shown in FIGS. 1A and 1B is arrayed on the medium supporting unit (not shown in figures) between the upper light generating unit 20A and the lower light generating unit 20B and rotated, while the focus of each laser beam released from the upper and lower light generating units 20A, 20B are positioned to be crossed at a certain recording region F by using the positioning units 25A, 25B and treating the region F thermally in accordance with binary code signals. As a result of the thermal treatment, the dispersed semiconductor particles gets bonded to each other, forming a crystal structure. The reference numeral 13 indicates where nanometer-sized crystalline semiconductor is formed 13. Recording region can be shifted by controlling the upper and lower light generating units 20A, 20B using the positioning units 25A, 25B up and down. Optical data are stored through repetition of recording region shift and thermal treatment.

In this procedure of recording data, the wavelength _{—1}, _{—2} of each pulse laser radiating from the first pulse laser generator 21A and the second pulse laser generator 22A may or may not be the same to each other. Energy of each pulse laser should be lower than the semiconductor dispersion layer 11 of the optical data storage medium 10, that is, the energy gap of the optically transparent medium. And the sum total of the energies of the two pulse lasers should be higher than the energy gap of the semiconductor dispersion layer 11.

In the mean time, in case the pulse width of a laser is less than 10⁻⁹ second, two-photon absorption effect can be obtained with only one light generating unit 30 in the optical data storage device of FIG. 3.

The optical data storage medium 10 of a structure shown in FIGS. 1A and 1B is arrayed on the medium supporting unit (not shown in figures) placed in the lower part of the light generating unit 40A and rotated, while the focus of a laser beam released from the light generating unit 40A is positioned to be crossed at a certain recording region F by using the positioning unit 45A, and crystal structure is formed by treating the recording region F thermally in accordance with binary code signals. Here, the laser wavelength_{—1} should be higher than the energy gap of the medium, the semiconductor dispersion layer of the optical data storage medium 10.

A method of searching for data using the optical data recording and searching device of FIG. 4 will be described hereinafter.

Just as the recording procedure, in this procedure of data searching, the optical data storage medium 10 is arrayed on the medium supporting unit (not shown in figures) between the upper light generating and detecting unit 40A and the lower light generating unit 40B and rotated, while the focus of the laser beam released from the first pulse laser generator 41A is controlled to be crossed at a certain searching region by using the positioning units 45A, 45B and a certain searching region is radiated with the pulse laser beam. The two-photon excited luminescence is performed where nanometer-sized crystalline semiconductor is formed 13, but not in the region where crystal is not formed. So, it is possible to playback the binary code recorded by the luminescence. A luminescence beam is detected by a light detector 47A equipped with an optical separator 46A. The light splitter distinguishes the wavelength of a searching laser from that of a luminescence beam. Searching region can be shifted by controlling the upper light generating and detecting unit 40A using the positioning units 45A, 45B up and down right and left. Playback or searching of optical data is conducted through the process.

The frequencies of each pulse lasers used in the data searching process based on two-photon absorption may or may not be the same as that of a laser used in the data recording process. And the frequencies of the two pulse lasers used in the data searching process may or may not be the same to each other. However, the sum total of the energies of the two pulse lasers should be higher than the energy gap of the nanometer-sized crystalline semiconductor.

In the mean time, as in the data recording process, in case the pulse width is less than 10⁻⁹ second, two-photon absorption effect can be obtained even when using a device equipped with only one light generating and detecting unit 50 seen in FIG. 5.

That is, just like the data recording process, in the data searching process, the optical data storage medium 10 is arrayed on the medium supporting unit (not shown in figures) placed in the lower part of the light generating and detecting unit 50 and rotated, while the focus of a laser beam released from the first pulse laser generating unit 51 is positioned to be crossed at a certain data searching region by using the positioning unit 55 and the pulse laser beam is radiated on the data searching region continuously.

A luminescence beam is detected by a light detector 57 equipped with an optical separator 56. The optical separator distinguishes the wavelength of a searching laser from that of a luminescence beam. Searching region can be shifted by controlling the upper light generating and detecting unit 40A using the positioning units 45A, 45B up and down right and left. Playback or searching of optical data you want to search is conducted through the process. The laser wavelength ₋₁ should be higher than half the energy gap of the crystalline semiconductor.

Meanwhile, in data searching process based on a single-photon absorption, when the wavelength of a laser used continuously is higher than the energy gap of the nanometer-sized crystalline semiconductor, light intensity filter (not shown in figures) for removing relatively weak luminescence signal emitted from adjacent region may be attached in the front of the light detector 47A.

The present invention described so far has advantages of easy multi-layer optical data recording because its data recording unit is based on the formation of crystalline semiconductor using two-photon absorption and its data searching unit is based on the luminescence of crystalline semiconductor excited by a single-photon or two-photon, and of high data stability because the recording process is irreversible. With a medium like glass mechanically solider than plastics, it's good to use in bad condition.

While the present invention has been described with respect to certain preferred embodiments, it will be apparent to those skilled in the art that various changes and modifications may be made without departing from the scope of the invention as defined in the following claims.

What is claimed is:

1. An optical data storage medium, comprising:
a plurality of recording layers, each of the recording layers being transparent to a light beam incident thereto and dispersed with a semiconductor material; and
a number of spacers formed adjacent to the recording layers.

2. The optical data storage medium as recited in claim 1, wherein the semiconductor material in the recording layers is crystallized in the order of nanometer.

3. The optical data storage medium as recited in claim 1, wherein the recording layers are made of silica.

4. The optical data storage medium as recited in claim 3, wherein the semiconductor material includes Si or Ge.

5. The optical data storage medium as recited in claim 3, wherein the transparent thin layers are doped with Er or Eu.

6. An optical data storage device, comprising:
a first laser generating means for generating a first laser beam;
a first light generating means having a first condensing means placed in the lower part of the first laser generating means, for injecting the laser released from the first laser generating means to the optical data storage medium; and
an optical data medium supporting means placed in the lower part of the first light generating means.

7. The optical data storage device as recited in claim 6, further comprising:
a second laser generating means for generating a second laser beam; and
a second light generating means having a second condensing means placed in the upper part of the second laser generating means for injecting the laser released from the second laser generating means to the optical data storage medium and confronts the first light generating means with the optical data storage medium in between.

8. The optical data storage device as recited in claim 7, wherein the first light generating means further includes a first optical filter positioned in the lower part of the first condensing means; and the second light generating means further includes a second optical filter positioned in the upper part of the second condensing means.

9. The optical data storage device as recited in claim 6, wherein the first light generating means and the second light generating means are controlled by a first positioning means and a second positioning means which are connected to a data processing means.

10. An optical data recording and searching device, comprising:
a first laser generating means for generating a first laser beam;
a first condensing means placed in the lower part of the first laser generating means for injecting the laser released from the first laser generating means to the optical data storage medium;
an optical separating means placed between the first laser generating means and the condensing means, for separating the laser beam and the luminescence beam;
a first light generating and detecting means having a light detecting means for detecting the luminescence beam transmitted from the optical separating means; and
an optical data medium supporting means placed in the lower part of the first light generating and detecting means.

11. The optical data recording and searching device as recited in claim 10, further comprising:
a second laser generating means for generating a second laser beam;
a second light generating and detecting means having a second condensing means placed in the upper part of the second laser generating means for injecting the laser released from the second laser generating means and confronts the first light generating and detecting means with the optical data storage means in between.

12. The optical data recording and searching device as recited in claim 11, wherein the first light generating means further includes a first optical filter in the lower part of the first condensing means; and the second light generating means further includes a second optical filter in the upper part of the second condensing means.

13. The optical data recording and searching device as recited in claim 10, wherein the first light generating means and the second light generating means are controlled by a first positioning means and a second positioning means respectively.

14. The optical data recording and searching device as recited in claim 13, further including a light intensity filtering means on the surface of the light detecting means.

15. A method for recording optical data based on an optical data storage device, wherein the optical data storage device includes a first laser generating means, a first light generating means and an optical data medium supporting means, the method comprising the steps of:
a) placing an optical data storage medium in which a plurality of transparent thin layers dispersed with semiconductor and transparent space layers are piled up alternately on the lower part of the first light generating means;
b) rotating the optical data storage medium and arraying focus of the beam released from the first light generating means on the data recording region; and
c) radiating the laser beam according to data binary code signals and crystallizing the data recording region by treating thermally.

16. The method as recited in claim 15, wherein in the step c), a laser beam with the pulse width of less than 10⁻⁹sec is radiated.

17. The method as recited in claim 16, wherein in the step c), the energy of the laser released from the first laser generating means is higher than half the energy gap of the transparent thin layer.

18. The method as recited in claim 17, wherein a serial process of the step b) leading to step c) is performed at least once.

19. A method for recording optical data based on an optical data storage device, wherein the optical data storage device includes a first laser generating means, a first light generating means, a second laser generating means, a second light generating means and an optical data medium supporting means, the method comprising the steps of:
a) placing an optical data storage medium in which a plurality of transparent thin layers dispersed with semiconductor and transparent space layers are piled up alternately between the first light generating means and the second light generating means;
b) rotating the optical data storage medium and arraying the focus of each beam released from the first and second light generating means to be crossed on the data recording region; and
c) radiating laser beams from the first and second laser generating means according to data binary code signals and crystallizing the data recording region by treating thermally.

20. The method as recited in claim 19, wherein in the step c), each energy emitted from the first and second laser generating means is lower than the energy gap of the transparent thin layer, and the sum total of the energies of the two laser beams is higher than the energy gap of the transparent thin layer.

21. The method as recited in claim 20, wherein a serial process of the step b) leading to step c) is performed at least once.

22. A method for searching for optical data based on an optical data storage and detection device, wherein the optical data storage and detection device includes a first laser generating means, a first condensing means, an optical separating means, a first light generating and detecting means and an optical data medium supporting means, the method comprising the steps of:
a) placing an optical data storage medium in which a plurality of transparent thin layers dispersed with semiconductor and transparent space layers are piled up alternately in the lower part of the first light generating and detecting means;
b) rotating the optical data storage medium and arraying the focus of a beam released from the first laser generating means on a certain data searching region;
c) radiating a laser on the data searching region; and
d) detecting the luminescence obtained from the crystalline semiconductor with a light detecting means of the first light generating and detecting means.

23. The method as recited in claim 22, wherein the energy released from the first laser generating means is higher than half the energy gap of the crystalline semiconductor.

24. A method of optical data searching based on an optical data storage and detection device, wherein the optical data storage and detection device includes a first laser generating means, a first condensing means, an optical separating means, a first light generating and detecting means, an optical data medium supporting means, a second laser generating means and a second light generating means, the method comprising the steps of:
a) placing an optical data storage medium in which a plurality of transparent thin layers dispersed with semiconductor and transparent space layers are piled up alternately between the first light generating and detecting means and the second light generating and detecting means;
b) rotating the optical data storage medium and arraying the focus of each beam released from the first and the second laser generating means to be crossed on a data searching region;
c) radiating a laser from the first and second laser generating means on the searching region; and
d) detecting the luminescence obtained from the crystalline semiconductor with a light detecting means of first light generating and detecting means.

25. The method as recited in claim 24, wherein in the step c), the sum total of energies of the two lasers released from the first and second laser generating means is higher than the energy gap of the crystalline semiconductor.

26. The method as recited in claim 25, wherein a serial process of the steps b) to d) is performed at least once.
